(19) United States
(12) Patent Application Publication
(10) Pub. No.: US 2015/0363312 A1
(43) Pub. Date: Dec. 17, 2015

(54) ELECTRONIC SYSTEM WITH MEMORY CONTROL MECHANISM AND METHOD OF OPERATION THEREOF

(71) Applicant: Samsung Electronics Co., Ltd., Suwon-si (KR)

(72) Inventors: Hongzhong Zheng, Sunnyvale, CA (US); Krishna Malladi, San Jose, CA (US); Steven Shrader, Fremont, CA (US)

(21) Appl. No.: 14/563,710

(22) Filed: Dec. 8, 2014

Related U.S. Application Data
(60) Provisional application No. 62/011,509, filed on Jun. 12, 2014.

(51) Int. Cl. G06F 12/08

(52) U.S. Cl. CPC G06F 12/084; G06F 12/0842; G06F 2212/1016; G06F 2212/62

(57) ABSTRACT

An electronic system includes: a second memory module; a first memory module coupled to the second memory module; and a multicast controller for managing a cache on the first memory module for the second memory module.

### CROSS-REFERENCE TO RELATED APPLICATION(S)

This application claims the benefit of U.S. Provisional Patent Application Ser. No. 62/011,509 filed Jun. 12, 2014, and the subject matter thereof is incorporated herein by reference thereto.

### TECHNICAL FIELD

An embodiment of the present invention relates generally to an electronic system, and more particularly to a system with memory control.

### BACKGROUND

Modern consumer and industrial electronics, especially devices such as graphical display systems, televisions, projectors, cellular phones, portable digital assistants, and combination devices, are providing increasing levels of functionality to support modern life. Research and development in the existing technologies can take a myriad of different directions.

The increasing levels of functionality typically require commensurate memory. Memory capacity and bandwidth can be key factors in increasing device or system performance and functionality. As with other electronic components or modules, area and cost of memory are traded off with performance and functionality.

Memory data caching can improve device or system performance and functionality. Unfortunately explicit memory transactions for data caching consume lots of memory bandwidth, introduce many memory access conflicts, and consume lots of CPU cycles, all of which reduce the improvements in system performance and functionality.

Thus, a need still remains for an electronic system with memory control mechanism to improve system performance. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### SUMMARY

An embodiment of the present invention provides an electronic system including: a second memory module; a first memory module coupled to the second memory module; and a multicast controller for managing a cache on the first memory module for the second memory module.

An embodiment of the present invention provides a method of operation of an electronic system including: providing a second memory module; coupling a first memory module to the second memory module; and managing a cache, with a multicast controller, on the first memory module for the second memory module.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is an exemplary block diagram of the electronic system 100 in an embodiment of the invention.

FIG. 2 is a plan view of a multidrop channel of the electronic system in an embodiment of the invention.

FIG. 3 is a plan view of a multicast channel of the electronic system in an embodiment of the invention.

FIG. 4 is a plan view of the multicast controller of the electronic system in an embodiment of the invention.

FIG. 5 is a control flow of a multicast process of the electronic system in an embodiment of the invention.

FIG. 6 is exemplary embodiments of the electronic system.

FIG. 7 is a flow chart of a method of operation of the electronic system in an embodiment of the present invention.

### DETAILED DESCRIPTION

A main memory system in an embodiment of the invention can use a multidrop memory channel to connect more than one DRAM memory module within a channel for a good balance of capacity and bandwidth. DRAM has access latency of SOns. Emerging memory technologies such as PCM, STT-MRAM, “slow” DRAM, other New Memory Technology (NMT), and ReRAM etc. are projected to have higher capacity, but slower access latency (500 ns to 5 us) than DRAM, and can fill a latency gap between DRAM and Flash memory.

A hybrid memory channel architecture in an embodiment of the invention can include both fast DRAM modules and slower emerging memory modules into a single multidrop memory channel. A hybrid memory channel controller in an embodiment of the invention organizes fast DRAM module as a cache for slower emerging memory modules through explicit memory transactions of moving data among fast and slow memory modules, involving the CPU in the critical path.

In an embodiment of the invention, the hybrid memory channel architecture can also include low and high energy efficient memory modules, low and high security memory modules, or combination thereof, into a single multidrop memory channel. A hybrid memory channel controller in an embodiment of the invention organizes some modules as a cache for other memory modules through explicit memory transactions of moving data among memory modules, involving the CPU in the critical path.

The following embodiments are described in sufficient detail to enable those skilled in the art to make and use the invention. It is to be understood that other embodiments would be evident based on the present disclosure, and that system, process, or mechanical changes may be made without departing from the scope of an embodiment of the present invention.

In the following description, numerous specific details are given to provide a thorough understanding of the invention. However, it will be apparent that the invention may be practiced without these specific details. In order to avoid obscuring an embodiment of the present invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation. The embodiments have been numbered first embodiment, second embodiment, etc. as a matter of descriptive convenience and are not intended to have any other significance or provide limitations for an embodiment of the present invention.

The term “module” referred to herein can include software, hardware, or a combination thereof in an embodiment of the present invention in accordance with the context in which the term is used. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof. Further, if a module is written in the apparatus claims section below, the modules are deemed to include hardware circuitry for the purposes and the scope of apparatus claims.

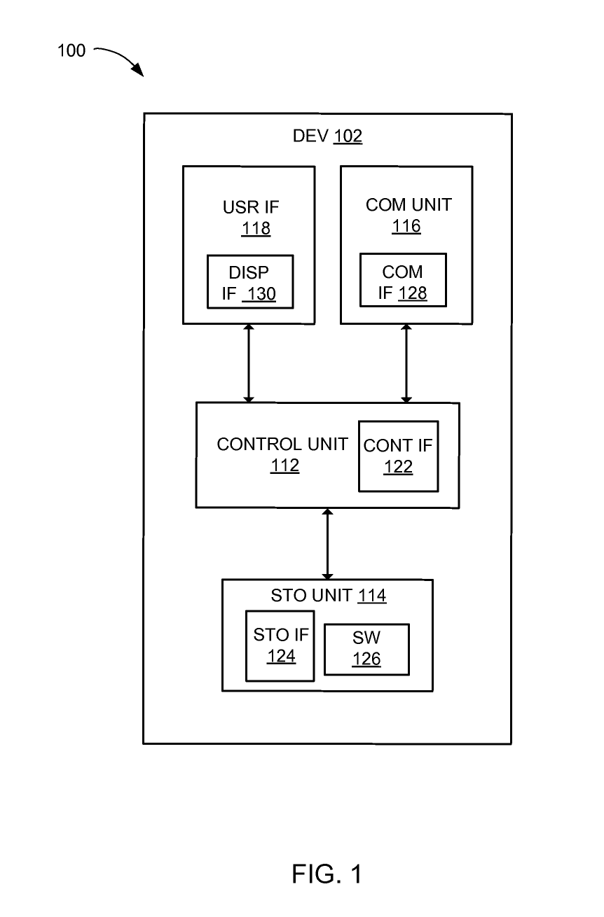

Referring now to FIG. 1, therein is shown an exemplary block diagram of the electronic system 100 in an embodiment of the invention. The electronic system 100 can include a device 102. The device 102 can include a client device, a server, a display interface, or combination thereof.

The device 102 can include a control unit 112, a storage unit 114, a communication unit 116, and a user interface 118. The control unit 112 can include a control interface 122. The control unit 112 can execute software 126 of the electronic system 100.

The control unit 112 can be implemented in a number of different manners. For example, the control unit 112 can be a processor, an application specific integrated circuit (ASIC) an embedded processor, a microprocessor, a hardware control logic, a hardware finite state machine (FSM), a digital signal processor (DSP), or a combination thereof. The control interface 122 can be used for communication between the control unit 112 and other functional units in the device 102. The control interface 122 can also be used for communication that is external to the device 102.

The control interface 122 can receive information from the other functional units or from external sources, or can transmit information to the other functional units or to external destinations. The external sources and the external destinations refer to sources and destinations external to the device 102.

The control interface 122 can be implemented in different ways and can include different implementations depending on which functional units or external units are being interfaced with the control interface 122. For example, the control interface 122 can be implemented with a pressure sensor, an inertial sensor, a microelectromechanical system (MEMS), optical circuitry, waveguides, wireless circuitry, wireline circuitry, or a combination thereof.

The storage unit 114 can store the software 126. The storage unit 114 can also store relevant information, such as data, images, programs, sound files, or a combination thereof. The storage unit 114 can be sized to provide additional storage capacity.

The storage unit 114 can be a volatile memory, a nonvolatile memory, an internal memory, an external memory, or a combination thereof. For example, the storage unit 114 can be a nonvolatile storage such as non-volatile random access memory (NVRAM), Flash memory, disk storage, or a volatile storage such as static random access memory (SRAM), dynamic random access memory (DRAM), emerging memory technologies including phase change memory (PCM) and resistance random access memory (ReRAM), or combination thereof.

The storage unit 114 can include a storage interface 124. The storage interface 124 can be used for communication with and other functional units in the device 102. The storage interface 124 can also be used for communication that is external to the device 102.

The storage interface 124 can receive information from the other functional units or from external sources, or can transmit information to the other functional units or to external destinations. The external sources and the external destinations refer to sources and destinations external to the device 102.

The storage interface 124 can include different implementations depending on which functional units or external units are being interfaced with the storage unit 114. The storage interface 124 can be implemented with technologies and techniques similar to the implementation of the control interface 122.

For illustrative purposes, the storage unit 114 is shown as a single element, although it is understood that the storage unit 114 can be a plurality of storage elements. Also for illustrative purposes, the electronic system 100 is shown with the storage unit 114 as a single hierarchy storage system, although it is understood that the electronic system 100 can have the storage unit 114 in a different configuration. For example, the storage unit 114 can be formed with different storage technologies forming a memory hierarchal system including different levels of caching, main memory, rotating media, or off-line storage.

The communication unit 116 can enable external communication to and from the device 102. For example, the communication unit 116 can permit the device 102 to communicate with a second device (not shown), an attachment, such as a peripheral device, a communication path (not shown), or combination thereof.

The communication unit 116 can also function as a communication hub allowing the device 102 to function as part of a communication path and not limited to be an end point or terminal unit of the communication path. The communication unit 116 can include active and passive components, such as microelectronics or an antenna, for interaction with the communication path.

The communication unit 116 can include a communication interface 128. The communication interface 128 can be used for communication between the communication unit 116 and other functional units in the device 102. The communication interface 128 can receive information from the other functional units or can transmit information to the other functional units.

The communication interface 128 can include different implementations depending on which functional units are being interfaced with the communication unit 116. The communication interface 128 can be implemented with technologies and techniques similar to the implementation of the control interface 122, the storage interface 124, or combination thereof.

The user interface 118 allows a user (not shown) to interface and interact with the device 102. The user interface 118 can include an input device, an output device, or combination thereof. Examples of input devices of the user interface 118 can include a keypad, a touchpad, soft-keys, a keyboard, a microphone, an infrared sensor for receiving remote signals, other input devices, or any combination thereof to provide data and communication inputs.

The user interface 118 can include a display interface 130. The display interface 130 can include a display, a projector, a video screen, a speaker, or any combination thereof.

The control unit 112 can operate the user interface 118 to display information generated by the electronic system 100. The control unit 112 can also execute the software 126 for the other functions of the electronic system 100. The control unit 112 can further execute the software 126 for interaction with the communication path via the communication unit 116.

The device 102 can also be optimized for implementing an embodiment of the electronic system 100 in a multiple device embodiment. The device 102 can provide additional or higher performance processing power.

The electronic system 100 can include the control unit 112. For illustrative purposes, the device 102 is shown partitioned with the user interface 118, the storage unit 114, the control unit 112, and the communication unit 116, although it is understood that the device 102 can have any different partitioning. For example, the software 126 can be partitioned differently such that at least some function can be in the control unit 112 and the communication unit 116. Also, the device 102 can include other functional units not shown for clarity.

The functional units in the device 102 can work individually and independently of the other functional units. For illustrative purposes, the electronic system 100 is described by operation of the device 102 although it is understood that the device 102 can operate any of the processes and functions of the electronic system 100.

Processes in this application can be hardware implementations, hardware circuitry, or hardware accelerators in the control unit 112. The processes can also be implemented within the device 102 but outside the control unit 112.

Processes in this application can be part of the software 126. These processes can also be stored in the storage unit 114. The control unit 112 can execute these processes for operating the electronic system 100.

The modules described in this application can be implemented as instructions stored on a non-transitory computer readable medium to be executed by a control unit 112. The non-transitory computer readable medium can include non-volatile memory, such as hard disk drives (HDD), non-volatile random access memory (NVRAM), solid-state storage device (SSD), compact disks (CD), digital video disks (DVD), universal serial busses (USB) flash memory devices, Blu-ray Discs™, any other computer readable media, or combination thereof. The non-transitory computer readable medium can be integrated as a part of the electronic system 100 or installed as a removable portion of the electronic system 100. The non-transitory computer medium can include the storage unit 114.

The modules described in this application can also be part of the software 126. These modules can also be stored in the storage unit 114. The control unit 112 can execute these modules for operating the electronic system 100.

The modules described in this application can be hardware implementations, hardware circuitry, or hardware accelerators in the control unit 112. The modules can also be hardware implementations, hardware circuitry, or hardware accelerators within the device 102 but outside of the first control unit 112.

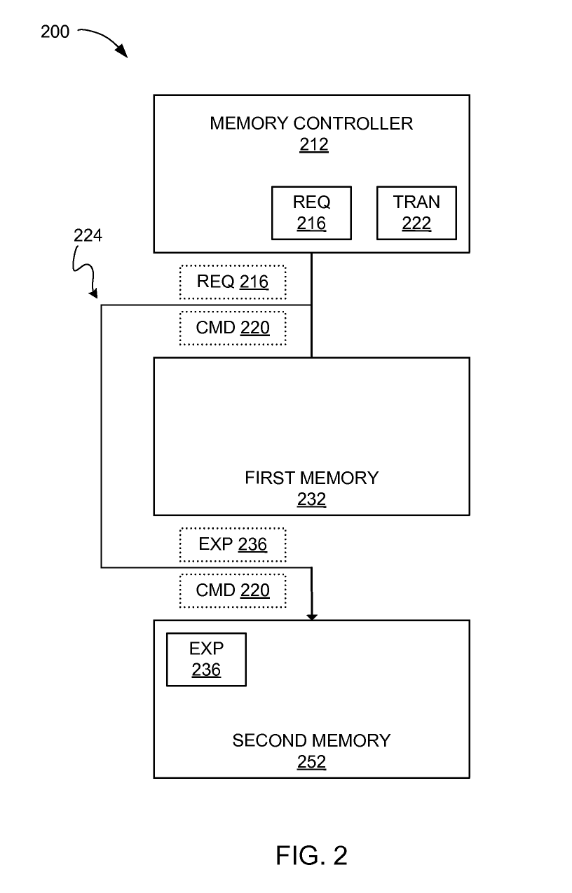

Referring now to FIG. 2, therein is shown a plan view of a multidrop channel 200 of the electronic system 100 in an embodiment of the invention. The multidrop channel 200 can provide memory transactions for moving data among memory modules, particularly with data caching. Moving data among memory modules can provide improved system performance, reduce overhead of the memory transactions, reduce the area of the memory modules, reduce cost, or combination thereof. Due at least in part to lower capability memory modules that can be less expensive and denser than higher capability memory modules, the lower capability memory modules can have much larger capacities and smaller footprints than the higher capability memory modules.

The multidrop channel 200 can provide a multidrop memory channel architecture. The multidrop memory channel architecture of the multidrop channel 200 can include a memory controller 212 and a requested data 216. The memory controller 212 can provide multidrop commands 220 including an explicit transaction 222 on a multidrop bus 224 for a first memory module 232 to provide explicit transaction data 236 to a second memory module 252.

The explicit transaction 222 can include commands specific to memory processes without automatic processes. Similarly the explicit transaction data 236 can include data specific to memory processes without automatic processes. Without automatic processes, the explicit transaction 222 must specify particular processes and particular data such as the explicit transaction data 236.

The multidrop bus 224 can provide data including the requested data 216, commands such as memory commands, the multidrop commands 220, or a combination thereof. The data and the commands on the multidrop bus 224 can be shared with the memory modules such as the first memory module 232, the second memory module 252, or combination thereof.

The memory controller 212 can provide the requested data 216 for caching in the first memory module 232. The requested data 216 can be provided on a multidrop bus 224 and ignored by the second memory module 252. The second memory module 252 can read the explicit transaction data 236, such as the requested data 216, a portion of the requested data 216, other data, or combination thereof, provided on the multidrop bus 224 by the first memory module 232 based on the explicit transaction 222 of the memory controller 212.

The electronic system 100 including the memory controller 212, the first memory module 232, the second memory module 252, or combination thereof, can be implemented in the control unit 112 of FIG. 1, the storage unit 114 of FIG. 1, the storage interface 124 of FIG. 1, or combination thereof. For illustrative purposes, the electronic system 100 is described by operation of the device 102 of FIG. 1. It is understood that the device 102 can operate any of the modules and functions of the electronic system 100.

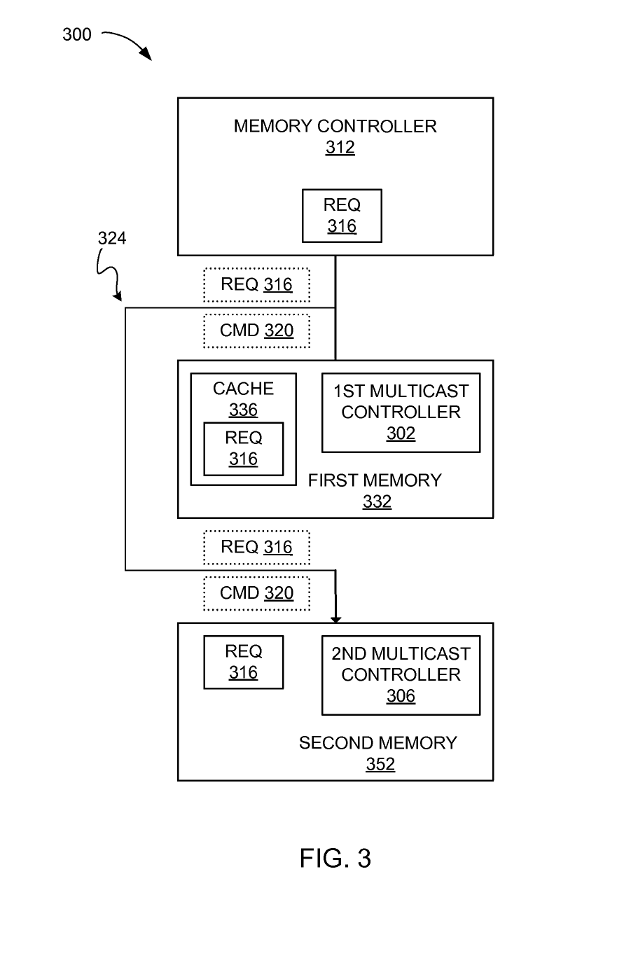

Referring now to FIG. 3, therein is shown a plan view of a multicast channel 300 of the electronic system 100 in an embodiment of the invention. The multicast channel 300 can provide memory transactions for moving data among memory modules, particularly with data caching. Moving data among memory modules can provide improved system performance, reduce overhead of the memory transactions, reduce area of the memory modules, reduce cost, or a combination thereof. Due at least in part to lower capability memory modules that can be less expensive and denser than higher capability memory modules, the lower capability memory modules can have much larger capacities and smaller footprints than the higher capability memory modules.

The multicast channel 300 can include a first multicast controller 302 and a second multicast controller 306. The first multicast controller 302 can be included, associated, coupled, or a combination thereof, with a memory module. The second multicast module 306 can be included, associated, coupled, or a combination thereof, with another memory module. For illustrative purposes the first multicast controller 302 and the second multicast module 306 are shown as different controllers although it is understood that they may also be the same.

The multicast channel 300 can provide a multicast memory channel architecture. The multicast memory channel architecture of the multicast channel 300 can include a memory controller 312 and a requested data 316 based on a multicast command 320. The memory controller 312 can provide the requested data 316 on a multicast bus 324 for a first memory module 332, a cache 336 of the first memory module 332, a second memory module 352, or combination thereof. The multicast bus 324 can provide data including the requested data 316, commands such as memory commands, multicast commands 320, or combination thereof. The data and the commands on the multicast bus 324 can be shared with the memory modules such as the first memory module 332, the second memory module 352, or combination thereof.

The multicast memory channel architecture of the multicast channel 300 can broadcast the requested data 316, such as a cache line read of the second memory module 352 including demand memory transactions such as the multicast command 320, on the multicast bus 324. The first memory module 332 can be coupled to the second memory module 352 with the multicast bus 324. The first memory module 332 can store the requested data 316 in the cache 336 for reducing memory request latency for further memory access. The second memory module 352 can also receive, store, respond to, or a combination thereof, the requested data 316 broadcast on the multicast bus 324. Irrelevant modules (to the specific requested data 316) can ignore the requested data 316 that can be broadcast on the multicast bus 324.

In an embodiment of the invention, the first multicast controller 302 and the first memory module 332 can automatically receive, store, cache, or a combination thereof, the requested data 316 broadcast on the multicast bus 324. The first memory module 332 can also automatically manage the requested data 316 as 1 cache 336 for the second memory module 352. A request, such as a request from the second memory module 362 and the second multicast controller 306, the multicast command 320, or combination thereof, for the requested data 316, can be filled from the cache 336 of the first memory module 332, and can reduce memory request latency.

Explicit memory transactions, such as the explicit transactions 222 of FIG. 2, for the requested data 316 in the cache 336 of the first memory module 332 provided to the second memory module 352 can be reduced or eliminated. Thus, the first multicast controller 302, the second multicast controller 306, or a combination thereof, can reduce or eliminate memory bandwidth consumption, memory transaction conflicts, or combination thereof, thereby improving system performance, improving energy efficiency, enabling new memory technologies, enabling compatibility with current memory hierarchies, providing transparent implementation for user applications, or combination thereof.

For illustrative purposes, the multicast channel 300 is shown with the requested data 316 on the multicast bus 324 and in the second memory module 362 although it is understood that the requested data 316 may be provided by the cache 336 of the first memory module 332. The second memory module 352 can receive, store, respond to, or a combination thereof, the requested data 316 broadcast on the multicast bus 324 although the multicast channel 300 of the electronic system 100 can also provide the requested data 316 with the cache 336, reducing or eliminating memory bandwidth consumption, memory transaction conflicts, or combination thereof.

It has been discovered that the electronic system 100 with the multicast channel 300 improves system performance, improves energy efficiency, enables new memory technologies, enables compatibility with current memory hierarchies, provides transparent implementation for user applications, or combination thereof. The multicast channel 300 with the first multicast controller 302, the second multicast controller 306, or combination thereof, provides the requested data 316 to the cache 336 of the first memory module 332.

The electronic system 100 including the memory controller 312, the first memory module 332, the second memory module 352, or a combination thereof, can be implemented in the control unit 112 of FIG. 1, the storage unit 114 of FIG. 1, the storage interface 124 of FIG. 1, or combination thereof. For illustrative purposes, the electronic system 100 is described by operation of the device 102 of FIG. 1.

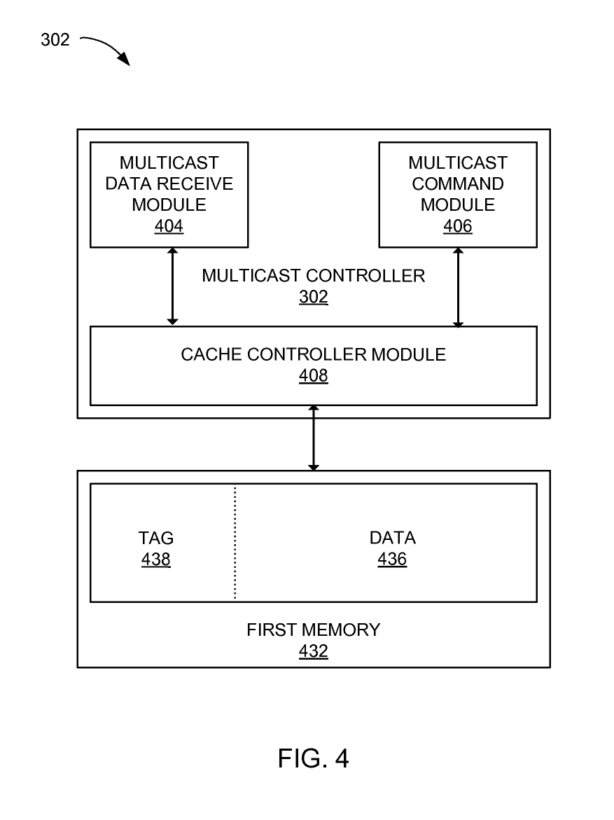

Referring now to FIG. 4, therein is shown a plan view of the multicast controller 302 of the electronic system 100 in an embodiment of the invention. The second multicast controller 306 (not shown) can be represented by the same or similar plan view. The first multicast controller 302, the second multicast controller 306, or combination thereof, can be implemented in physical logic circuitry to enable memory modules, such as the first memory module 332 of FIG. 3, the second memory module 352 of FIG. 3, or combination thereof, to reduce memory bandwidth consumption, eliminate memory bandwidth consumption, reduce memory transaction conflicts, eliminate memory transaction conflicts, or combination thereof.

The multicast controller 302 can include a data receive module 404 such as a multicast data receive module. The data receive module 404 can enable memory modules, such as the first memory module 332, the second memory module 352, or combination thereof, to receive data broadcast on the multicast bus 324 of FIG. 3. The data, such as the requested data 316 of FIG. 3, can be broadcast on the multicast bus 324 shared by the memory modules, such as the first memory module 332, the second memory module 352, or combination thereof.

The multicast controller 302 can also include a command module 406 such as a multicast command module. The command module 406 can receive memory commands, detect access patterns, send memory commands, or combination thereof. The command module 406 can receive the memory commands, such as the multicast commands 320 of FIG. 3, the multidrop commands 220 of FIG. 2, or combination thereof, that are broadcast on the multicast bus 324, the multidrop bus 224, or combination thereof, shared by the memory modules.

The command module 406 can also detect access patterns based on data, such detecting access patterns for the second memory module 352, the first memory module 332, or combination thereof, based on as the requested data 316. The command module 406 can further send memory commands, such as the multicast commands 320, to the multicast bus 324 for prefetching data, such as the requested data 316, from the second memory module 352 at idle times, for data caching.

The multicast controller 302 can further include a controller module 408 such as a cache controller module. The controller module 408 can be coupled to a first capability memory module 432 such as a low density fast memory module. The first capability memory module 432 in a manner similar to the first memory module 332, the first memory module 232 of FIG. 2, or combination thereof, can include data such as the requested data 316.

The controller module 408 can manage data 436, such as received broadcast data, the requested data 316, or combination thereof. The controller module 408 can also manage tags 438 associated with the received broadcast data 436. The data 436 and the tags 438 can be managed in a cache organization of the first capability memory module 432 for access by a second capability memory such as a slow high density memory or the second memory module 352.

The controller module 408 can also check broadcast commands, such as the multicast commands 320, for verifying that data, such as the requested data 316, is available in the data 436 of the first capability memory module 432. The controller module 408 can check the tags 438 to verify the data 436. Based on the tags 438 verifying that the data 436 is available, the controller module 408 can respond to a memory request, such as the multicast commands 320. Based on the tags 438 verifying that the data 436 is not available, the second memory module 352 can respond to the memory request, such as the multicast commands 320.

The controller module 408 can further provide data snooping for the data receive module 404 for snooping and receiving data, such as the requested data 316, broadcast from the second memory module 352. In an embodiment of the invention, the controller module 408 can issue read or write cancel commands, such as the multicast commands 320, based on memory requests, such as the multicast commands 320, provided by, responded to, serviced by, or a combination thereof, the first capability memory module 432.

The controller module 408 can yet further provide, respond to, schedule, or a combination thereof, memory commands, such as the multicast commands 320, for the command module 406. The command module 406 can send memory commands, such as the multicast commands 320, to the multicast bus 324 for prefetching data, such as the requested data 316, from the second memory module 352 at idle times for data caching.

For illustrative purposes the first multicast controller 302 is described above although it is understood that the second multicast controller 306 may be the same. The first multicast controller 302, the second multicast controller 306, or combination thereof, can be included, associated, coupled, or a combination thereof, with the first memory module 332, the second memory module 352, the first capability memory module, or a combination thereof.

It has been discovered that the electronic system 100 with the multicast controller 302 reduces memory bandwidth consumption, eliminates memory bandwidth consumption, reduces memory transaction conflicts, eliminates memory transaction conflicts, or a combination thereof. The multicast controller 302 includes the data receive module 404, the command module 406, and the controller module 408, for: enabling memory modules to receive the requested data 316, receiving the multicast commands 320, detecting access patterns, sending the multicast commands 320, managing the data 436, managing the tags 438, managing the multicast commands 320 for verifying data availability, managing the data snooping, managing cancel commands, or a combination thereof.

The electronic system 100 including the memory controller 312, the first memory module 332, the second memory module 352, or combination thereof, can be implemented in the control unit 112 of FIG. 1, the storage unit 114 of FIG. 1, the storage interface 124 of FIG. 1, or combination thereof.

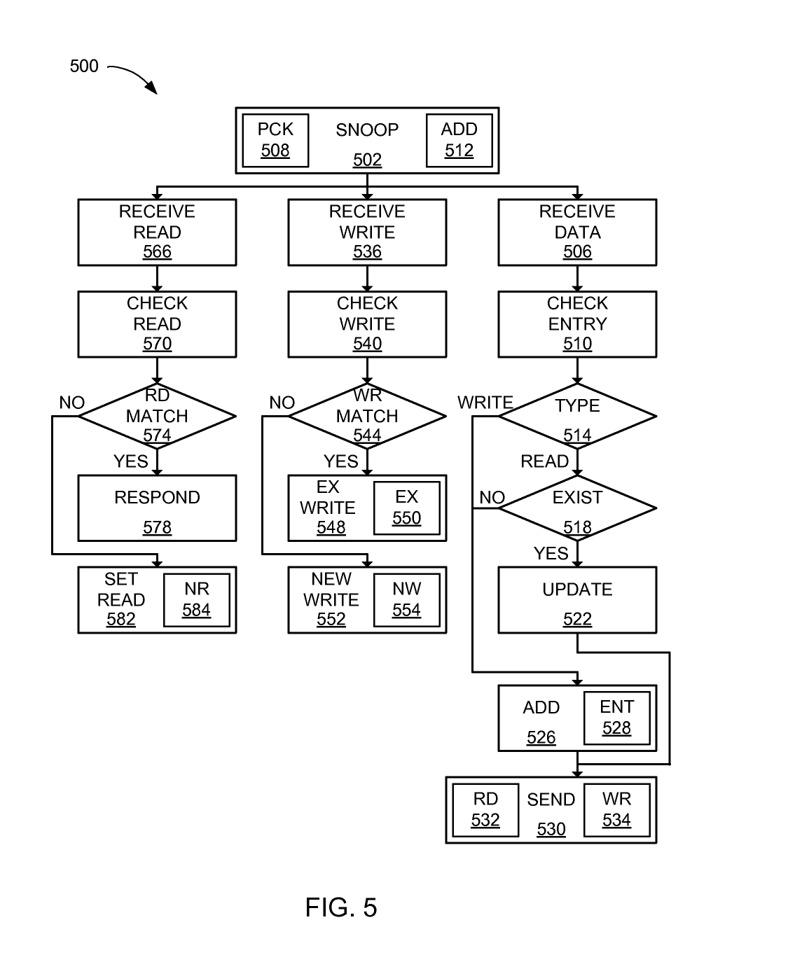

Referring now to FIG. 5, therein is shown a control flow of a multicast process 500 of the electronic system 100 in an embodiment of the invention. The multicast process 500 can provide memory transactions for moving data among memory modules, particularly with data caching. Moving data among memory modules can provide improved system performance, reduce overhead of the memory transactions, reduce area of the memory modules, reduce cost, reduce memory bandwidth consumption, eliminate memory bandwidth consumption, reduce memory transaction conflicts, eliminate memory transaction conflicts, or combination thereof.

The multicast process 500 of the electronic system 100 can be implemented with the multicast channel 300 with the first multicast controller 302, the second multicast controller 306, or a combination thereof. At least a portion of the multicast process 500 of the electronic system 100 can also be implemented with the multidrop channel 200 of FIG. 2. For illustrative purposes, the multicast process 500 is substantially described with the multicast channel 300 although it is understood that at least a portion of the multicast process 500 of the electronic system 100 can also be implemented with the multidrop channel 200.

The multicast process 500 can include a snoop process 502 for snooping, identifying, detecting, determining, or a combination thereof, data and commands on a shared command and data bus such as the multidrop bus 224 of FIG. 3, the multicast bus 324 of FIG. 3, or a combination thereof. The data such as the requested data 216 of FIG. 2, the requested data 316 of FIG. 3, the explicit transaction data 236 of FIG. 2, any other data, or a combination thereof. The commands can include the multidrop commands 220 of FIG. 2, the explicit transactions 222 of FIG. 2, the multicast commands 320 of FIG. 3, any commands, any other commands, or combination thereof.

A receive data process 506, coupled to the snoop process 502, is for receiving data packets 508 such as the requested data 216, the requested data 316, the explicit transaction data 236, any data, any other data, or combination thereof.

A check entry process 510, coupled to the receive data process 506, is for checking address entries 512 of the snoop process 502 associated with the data packets 508 received by the receive data process 506, and determining the type of the address entries 512.

A type decision process 514, coupled to the check entry process 510, can be configured to decide the next process based on the type of the address entries 512 of the snoop process 502. For example, a read type of the snoop address entry 512 can be provided to an exist decision process 518. The exist decision process 518, coupled to the type decision process 514, can be configured to decide a next process based on stored entries, such as the address entries 512, existing or not existing. Also for example, an existent of the address entries 512 can be provided to an update tag process 522. The update tag process 522 can be configured to update a tag such as the tags 438 of FIG. 4, and associating the updated of the tag 438 with the snoop address entry 512 and the data packet 508.

Further for example, the type decision process 514 can be configured to decide a write type of the snoop address entry 512 be provided to an add cache entry process 526. The add cache process 526, coupled to the type decision process 514, can be configured to add a cache entry 528 such as new cache entry. The exist decision process 518 can also be for deciding whether a non-existent of the address entries 512 can be provided to the add cache process 526.

A send cancel process 530, coupled to the update tag process 522, the add cache process 526, or a combination thereof, can be configured to send commands such as a read cancel 532, a write cancel 534, the multicast commands 320, or a combination thereof. The send cancel process 530 can be configured to send the read cancel 532, the write cancel 534, or combination thereof, to a high density slow memory module such as the second memory module 352 of FIG. 3, the second memory module 252 of FIG. 2, or combination thereof.

The first multicast controller 302, the second multicast controller 306, or combination thereof, sends the read cancel 532, the write cancel 534, or combination thereof, to the high density slow memory module. The high density slow memory module can accept, receive, store, respond to, or a combination thereof, a command such as the multicast command 320, the multidrop commands 220, or a combination thereof, and can then stop since a faster memory module, such as the first capability memory module 432, the first memory module 332, the first memory module 232, or a combination thereof, can complete the operation first.

In an embodiment of the invention, the multicast process 500 can include a receive write process 536 for receiving a write command such as the multicast commands 320, the multidrop commands 220, the explicit transactions 222, or combination thereof.

A check write process 540, coupled to the receive write process 536, is for checking an address tag, such as the tags 438 associated with the write command. The check write process 540 can compare, determine, verify, or a combination thereof, whether the address tag matches a stored address tag. The stored address tag can be a stored tag in a memory module such as the first capability memory module 432, the first memory module 332, the first memory module 232, the second memory module 352, the second memory module 252, or combination thereof.

A write decision process 544, coupled to the check write process 540, can be configured to decide a next process based on the address tag matching stored tags, such as the tags 438, existing or not existing. For example, a set existing snoop process 548 can be configured to set an existing write address data snoop 550 based on an existent of the stored tags determined by the write decision process 544. The existing write address data snoop 550 can be implemented by the snoop process 502.

Further for example, a set new snoop process 552, coupled to the write decision process 544, can be configured to set a new write address data snoop 554 based on a non-existent of the stored tags determined by the write decision process 544. The new write address data snoop 554 can be implemented by the snoop process 502.

In an embodiment of the invention, the multicast process 500 can include a receive read process 566 for receiving a read command such as the multicast commands 320, the multidrop commands 220, the explicit transactions 222, or combination thereof.

A check read process 570, coupled to the receive read process 566, is for checking an address tag, such as the tags 438 associated with the read command. The check read process 570 can compare, determine, verify, or a combination thereof, whether the address tag matches a stored address tag. The stored address tag can be a stored tag in a memory module such as the first capability memory module 432, the first memory module 332, the first memory module 232, the second memory module 352, the second memory module 252, or combination thereof.

A read decision process 574, coupled to the check read process 570, can be configured to decide a next process based on the address tag matching stored tags, such as the tags 438, existing or not existing. For example, a respond process 578 can be configured to respond to a read request to provide data, such as the data 436, the requested data 316, the explicit transaction data 236, or a combination thereof, based on an existent of the stored tags determined by the read decision process 574. The respond process 578 can provide a response to the read request from a first memory module such as the first capability memory module 432, the first memory module 332, the first memory module 232, or combination thereof.

Further for example, a set read process 582, coupled to the read decision process 574, can be configured to set a new read address snoop 584 based on a non-existent of the stored tags determined by the read decision process 574. The new read address snoop 584 can be implemented by the snoop process 502.

The electronic system 100 has been described with module functions or order as an example. The electronic system 100 can partition the modules differently or order the modules differently. For example, the receive read process 566 can include the check read process 570 and the read decision process 570 as separate modules although these modules can be combined into one. Also, the respond process 578 can be split into separate modules for implementing in the separate modules a request to a first memory module and a reply to a second memory module.

The control flow of the multicast process 500 of electronic system 100 including the memory controller 312, the first memory module 332, the second memory module 352, or combination thereof, can be implemented in the control unit 112 of FIG. 1, the storage unit 114 of FIG. 1, the storage interface 124 of FIG. 1, or combination thereof. For illustrative purposes, the electronic system 100 is described by operation of the device 102 of FIG. 1. It is understood that the device 102 can operate any of the modules and functions of the electronic system 100.

The electronic system 100 including the first multicast controller 302 can be implemented in the control unit 112, the storage unit 114, the storage interface 124, or combination thereof. For illustrative purposes, the electronic system 100 is described by operation of the device 102. It is understood that the device 102 can operate any of the modules and functions of the electronic system 100.

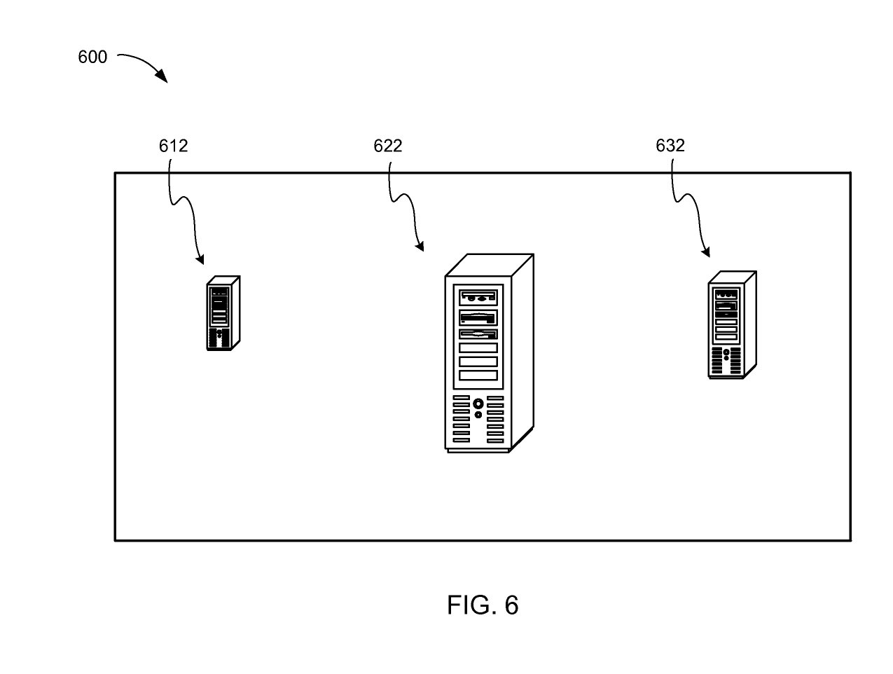

Referring now to FIG. 6, therein is shown exemplary embodiments of the electronic system 100. The exemplary embodiments include application examples for the electronic system 100 such as a client computer 612, a server rack 622, a server computer 632, or combination thereof.

These application examples illustrate purposes or functions of various embodiments of the invention and importance of improvements in processing performance including improved bandwidth, area-efficiency, or combination thereof. For example, the multicast process 500 of FIG. 5 can maximize system performance, minimize overhead of the memory transactions, minimize area of the memory modules, minimize cost, minimize memory bandwidth consumption, eliminate memory bandwidth consumption, minimize memory transaction conflicts, eliminate memory transaction conflicts, or combination thereof.

In an example where an embodiment of the invention is an integrated physical logic circuit and the multicast process 500 is integrated in the control unit 112, the storage unit 114, or combination thereof, cached transactions can be significantly faster than other devices without the multicast process 500. Various embodiments of the invention provide optimal scheduling of transactions thereby improving system performance, improving energy efficiency, enabling new memory technologies, enabling compatibility with current memory hierarchies, providing transparent implementation for user applications, or combination thereof.

The electronic system 100, such as the client computer 612, the server rack 622, and the server computer 632, can include one or more of a subsystem (not shown), such as a printed circuit board having various embodiments of the invention, or an electronic assembly (not shown) having various embodiments of the invention. The electronic system 100 can also be implemented as an adapter card in the client computer 612, the server rack 622, and the server computer 632, or combination thereof.

Thus, the client computer 612, the server rack 622, and the server computer 632, other electronic devices, or combination thereof, can provide significantly faster throughput with the electronic system 100 such as processing, output, transmission, storage, communication, display, other electronic functions, or combination thereof. For illustrative purposes, the client computer 612, the server rack 622, and the server computer 632, other electronic devices, or combination thereof, are shown although it is understood that the electronic system 100 can be used in any electronic device.

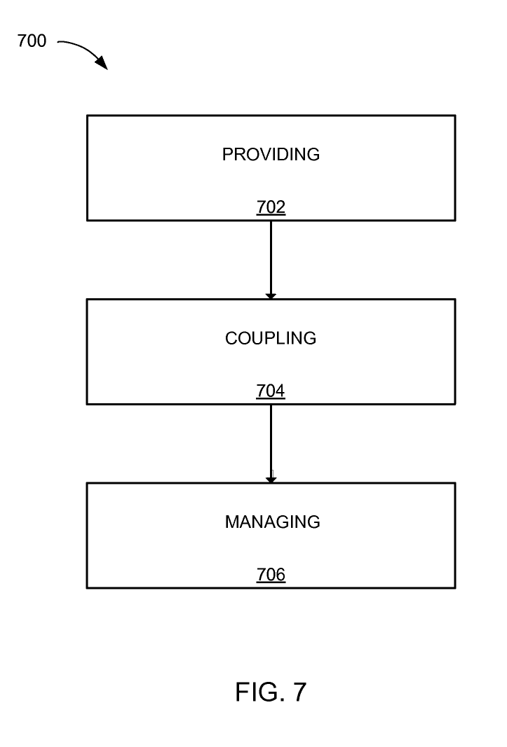

Referring now to FIG. 7, therein is shown a flow chart of a method 700 of operation of the electronic system 100 in an embodiment of the present invention. The method 700 includes: providing a second memory module in a block 702; coupling a first memory module to the second memory module in a block 704; and managing a cache, with a multicast controller, on the first memory module for the second memory module in a block 706.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of an embodiment of the present invention is that it valuably supports and services the historical trend of reducing costs, simplifying systems, and increasing performance.

These and other valuable aspects of an embodiment of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. An electronic system comprising:
a second memory module;
a first memory module coupled to the second memory module; and
a multicast controller for managing a cache on the first memory module for the second memory module.

2. The system as claimed in claim 1 wherein the second memory module is a high density memory module.

3. The system as claimed in claim 1 wherein the first memory module is a low density memory module.

4. The system as claimed in claim 1 further comprising a bus coupling the first memory module to the second memory module.

5. The system as claimed in claim 1 wherein the multicast controller is configured to include a data receive module.

6. The system as claimed in claim 1 wherein the multicast controller is configured to include a command module.

7. The system as claimed in claim 1 wherein the multicast controller is configured to include a controller module.

8. The system as claimed in claim 1 wherein the first memory module is configured to include data in the cache.

9. The system as claimed in claim 1 wherein the first memory module is configured to include a tag in the cache.

10. The system as claimed in claim 1 further comprising a memory controller coupled to the first memory module and the second memory module.

11. A method of operation of an electronic system comprising:
providing a second memory module;
coupling a first memory module to the second memory module; and
managing a cache, with a multicast controller, on the first memory module for the second memory module.

12. The method as claimed in claim 11 wherein providing the second memory module includes providing a high density memory module.

13. The method as claimed in claim 11 wherein coupling the first memory module includes coupling a low density memory module.

14. The method as claimed in claim 11 wherein coupling includes coupling the first memory module to the second memory module with a bus.

15. The method as claimed in claim 11 wherein managing the cache includes managing with a multicast controller that is configured to include a data receive module.

16. The method as claimed in claim 11 wherein managing the cache includes managing with a multicast controller that is configured to include a command module.

17. The method as claimed in claim 11 wherein managing the cache includes managing with a multicast controller that is configured to include a controller module.

18. The method as claimed in claim 11 wherein coupling includes coupling the first memory module that is configured to include data.

19. The method as claimed in claim 11 wherein coupling includes coupling the first memory module configured to include a tag.

20. The method as claimed in claim 11 further comprising coupling a memory controller to the first memory module and the second memory module.
